(19) United States
(12) Patent Application Publication
(10) Pub. No.: US 2018/0107311 A1
(43) Pub. Date: Apr. 19, 2018

(54) TOUCH SUBSTRATE AND METHOD OF MANUFACTURING THE SAME, TOUCH PANEL AND DISPLAY DEVICE

(71) Applicants: Boe Technology Group Co., Ltd., Beijing (CN); Hefei Boe Optoelectronics Technology Co., Ltd., Anhui (CN)

(72) Inventors: Guanjie Chen, Beijing (CN); Sangsoo Park, Beijing (CN); Xunze Zhang, Beijing (CN)

(73) Assignees: Boe Technology Group Co., Ltd., Beijing (CN); Hefei Boe Optoelectronics Technology Co., Ltd., Anhui (CN)

(21) Appl. No.: 15/504,102

(22) PCT Filed: Jul. 15, 2016
(86) PCT No.: PCT/CN16/90139

§ 371 Date: Feb. 15, 2017

(30) Foreign Application Priority Data
Jan. 11, 2016 (CN) 201610014290.4

(51) Int. Cl. G06F 3/041; G02F 1/1333

(52) U.S. Cl. CPC G06F 3/0412; G06F 2203/04103; G02F 1/13338

(57) ABSTRACT

A touch substrate, a touch panel, and a display device comprising the touch panel are disclosed. The touch substrate includes a base substrate; and a touch sensing layer located over the base substrate, the touch sensing layer comprising a photosensitive silver paste. A method of manufacturing a touch substrate comprises providing a base substrate; and forming a touch sensing layer over the base substrate, the touch sensing layer comprising a photosensitive silver paste.

### RELATED APPLICATIONS

The present application is the U.S. national phase entry of PCT/CN2016/090139, with an international filing date of Jul. 15, 2016, which claims the benefit of Chinese Patent Applications No. 201610014290.4, filed on Jan. 11, 2016, the entire disclosures of which are incorporated herein by reference.

### FIELD

The present disclosure relates to touch sensing technology, and particularly to a touch substrate and a method of manufacturing the same, a touch panel, and a display device comprising the touch panel.

### BACKGROUND

With the development of touch sensing technology, there have been a variety of ways to implement a touch panel. Most of these implementations are achieved by forming a touch sensing layer by indium tin oxide (ITO) material. Particularly, in a touch display technology called “single layer on cell” (SLOC), after cell alignment between the array substrate and the color film substrate is performed, a single ITO touch layer is formed on the backside of the color film substrate to realize the touch function. This technology is one of the on cell touch technologies.

In order to form an ITO sensing layer, a monolayer ITO pattern is formed on the backside of the color film substrate through a complicated process, mainly comprising pre-cleaning, film forming, patterning, etching, peeling, annealing, etc.

Although the touch sensing layer can be formed by ITO material, the existing process involves complicated flow, high technical difficulty, low production efficiency and high manufacturing cost.

### SUMMARY

Accordingly, it is desired to provide an improved touch substrate and a method of manufacturing the same, which can alleviate or avoid one or more of the problems described above.

In certain embodiments of the present disclosure, there is provided a touch substrate comprising: a base substrate; and a touch sensing layer located over the base substrate, the touch sensing layer comprising a photosensitive silver paste.

The photosensitive silver paste, also called photosensitive silver colloid, photolithographic silver colloid or photolithographic silver paste, is a known material, which can, for example, be applied to a narrow frame display device. The photosensitive silver paste may include a photosensitive component, a conductive component and an adhesive component. Depending on particular applications and needs, the photosensitive silver paste may also include other auxiliary components.

It has been found that the photosensitive silver paste material not only can be used as an electrode due to its good conductive property, but also has the characteristics of a photoresist such that it can be directly patterned by processes such as exposure, development and the like to form a desired pattern. Accordingly, if the touch sensing layer of the touch substrate is formed using the photosensitive silver paste material, there is no need to additionally form a photoresist pattern as in manufacturing a conventional ITO touch sensing layer. As a result, the process flow can be greatly simplified, the production efficiency can be improved, and the production cost can be reduced.

According to an embodiment of the present disclosure, a touch sensing layer may be formed on an upper surface of a base substrate.

In certain embodiments of the present disclosure, there is provided a touch panel, which may comprise the touch substrate described above.

According to an embodiment of the present disclosure, the base substrate may be a cover plate.

According to another embodiment of the present disclosure, the touch panel may further comprise a color film substrate located above the cover plate, and the touch sensing layer is formed on a surface of the cover plate facing the color film substrate.

According to another embodiment of the present disclosure, the touch panel may further include an array substrate located above the color film substrate, wherein a liquid crystal layer is disposed between the color film substrate and the array substrate.

According to another embodiment of the present disclosure, the base substrate may be a color film substrate.

According to another embodiment of the present disclosure, the touch panel may further comprise a cover plate located above the color film substrate.

According to a further embodiment of the present disclosure, the touch panel may further comprise an array substrate located below the color film substrate, wherein a liquid crystal layer is provided between the color film substrate and the array substrate.

By locating the touch sensing layer at different positions of the touch substrate, a variety of applications and/or requirements may be satisfied.

A touch panel for a display device can be formed by forming a touch sensing layer comprising a photosensitive silver paste on a color film substrate. Particularly, in the case that the touch panel comprises an array substrate located below the color film substrate and a liquid crystal layer is provided between the color film substrate and the array substrate, the touch panel can be used to form a liquid crystal display device having touch sensing function.

In certain embodiments of the present disclosure, there is provided a method of manufacturing a touch substrate, comprising: providing a base substrate; and forming a touch sensing layer over the base substrate, the touch sensing layer comprising a photosensitive silver paste.

As described above, if the touch sensing layer of the touch substrate is formed using the photosensitive silver paste material, there is no need to additionally form a photoresist pattern as in manufacturing a conventional ITO touch sensing layer. As a result, the process flow can be greatly simplified, the production efficiency can be improved, and the production cost can be reduced.

According to an embodiment of the present disclosure, forming a touch sensing layer over the base substrate comprises: forming a material layer comprising a photosensitive silver paste on an upper surface of the base substrate, and patterning the material layer to form a touch sensing layer.

According to another embodiment of the present disclosure, patterning the material layer to form a touch sensing layer comprises: exposing the material layer; and developing the exposed material layer so as to pattern the material layer to form a touch sensing layer.

Since the photosensitive silver paste material is used, there is no need to first form a photoresist pattern by processes such as coating, exposure, development and the like, and then etch the ITO material using the photoresist pattern as a mask so as to form a touch sensing layer, as in manufacturing a conventional ITO touch sensing layer. Instead, the material layer comprising the photosensitive silver paste can be directly patterned. In particular, the material layer can be directly exposed and developed to form a touch sensing layer. Thus, the existing process for forming a touch sensing layer has been simplified.

According to another embodiment of the present disclosure, prior to patterning the material layer comprising the photosensitive silver paste, the material layer may be cured.

Curing the material layer comprising the photosensitive silver paste makes the material layer more stable, thereby facilitating subsequent patterning process.

According to another embodiment of the present disclosure, the base substrate may be a cover plate.

According to another embodiment of the present disclosure, the base substrate may be a color film substrate.

According to a further aspect of the present disclosure, there is provided a display device, which may comprise the touch panel described above.

In the above touch panel, the method of manufacturing the touch panel, and the display device comprising the touch panel, since the touch sensing layer is formed using the photosensitive silver paste material, there is no need to additionally form a photoresist pattern as in manufacturing a conventional ITO touch sensing layer. As a result, the process flow can be greatly simplified, the production efficiency can be improved, and the production cost can be reduced.

### BRIEF DESCRIPTION OF DRAWINGS

The concept and other advantages of the present disclosure will now be described by way of non-limiting embodiments with reference to the accompanying drawings.

FIGS. 1A to 1F illustrate a conventional process flow of forming a touch sensing layer of a touch panel by an ITO material.

FIG. 2 illustrates a schematic diagram of a touch panel according to embodiments of the present disclosure.

FIGS. 3A and 3B illustrate an exemplary embodiment of a touch panel according to embodiments of the present disclosure, respectively.

FIG. 4 illustrates a schematic diagram of a method of manufacturing a touch panel according to embodiments of the present disclosure.

FIGS. 5A-5D illustrate an exemplary process flow of a method of manufacturing a touch panel according to embodiments of the disclosure.

### DETAILED DESCRIPTION

Specific examples of a touch panel, a display device, and a method of manufacturing a touch panel according to embodiments of the present disclosure will be described below by way of example with reference to the accompanying drawings. The drawings are schematic and not drawn to scale, which are only for the purpose of illustrating embodiments of the disclosure and not intended to limit the protection scope of the present disclosure.

It is to be understood that when an element or layer is referred to as being “on”, “over”, “above”, “connected to” or “coupled to” another element or layer, it may be directly on, connected to or coupled to another element or layer, or there may further exist an intervening element or layer. On the contrary, when an element is referred to as being “directly on”, “directly connected to” or “directly coupled to” another element or layer, there is no intervening element or layer.

To facilitate description, spatially relative terms such as “below”, “under”, “lower”, “over”, “upper”, and the like may be used herein to describe the relationship between one element or component and another element or component as illustrated. It is to be understood that spatially relative terms are intended to generalize different orientations of a device in use or operation other than those shown in the drawings. For example, if the device in the drawings is turned over, an element described as being “below” or “under” other elements or components would be “above” other elements or components. Thus, the exemplary term “under” can encompass two orientations of “over” and “below”. The device can take other orientations (rotated 90 degrees or in other orientations), and the spatial relativity descriptors used here are interpreted accordingly.

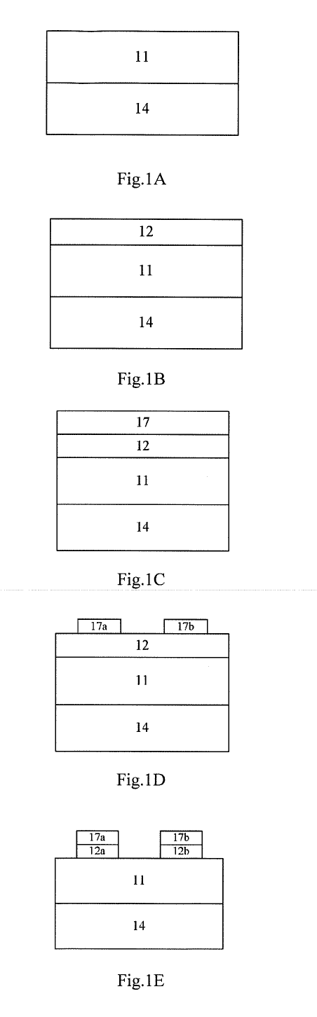

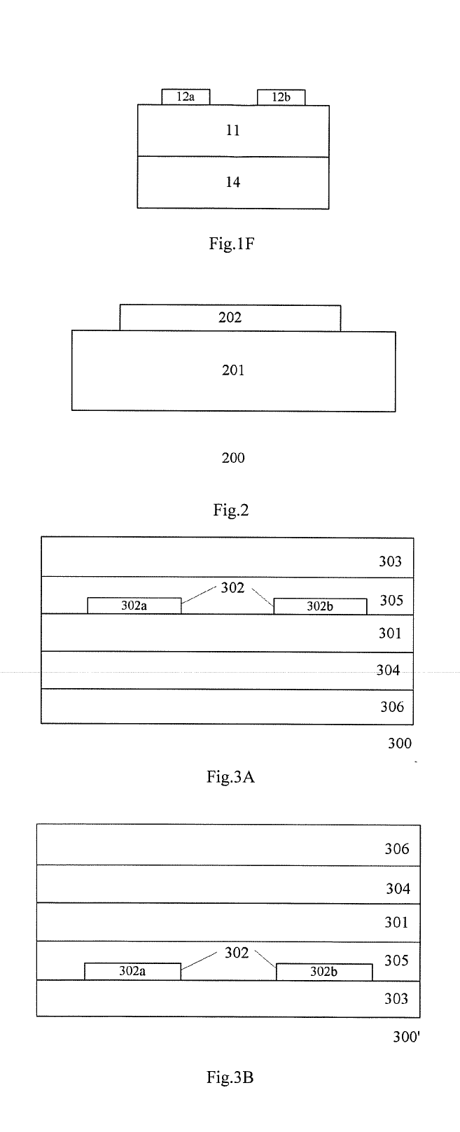

FIGS. 1A-1F illustrate a process flow for forming a touch sensing layer of a touch substrate by an ITO material.

As shown in FIG. 1A, a color film substrate 11 and an array substrate 14 after cell alignment are provided, and the surface of the color film substrate is pre-cleaned. Thereafter, as shown in FIG. 1B, film forming process is performed, that is, an ITO material layer 12 is formed on the backside of the color film substrate 11. In the film forming process, a magnetron sputtering machine is mostly used to form a uniform amorphous ITO thin film layer having a thickness of about 40 to 400 nm on the backside of the color film substrate. Then, as shown in FIGS. 1C-1D, photoresist patterns 17a and 17b are formed on the surface of the ITO material layer 12 by patterning process. More specifically, the photoresist patterns 17a and 17b are formed on the ITO material layer 12 by pre-cleaning, coating a photoresist layer 17, exposing the photoresist layer 17, developing the exposed photoresist layer 17, etc. Thereafter, as shown in FIG. 1E, the ITO material not covered by the photoresist patterns 17a and 17b is etched away by etching process using the photoresist patterns 17a and 17b as masks. Then, as shown in FIG. 1F, the photoresist patterns 17a and 17b are peeled off by peeling process, eventually leaving ITO patterns 12a and 12b to form a touch sensing layer. After the process of FIG. 1F, in order to reduce the impedance of the touch sensing layer and increase the hardness thereof, it is usually further required to subject the ITO to high temperature annealing treatment by annealing process so as to make it polycrystalline ITO.

FIG. 2 illustrates a schematic diagram of a touch substrate according to embodiments of the present disclosure.

As shown in FIG. 2, a touch substrate 200 according to embodiments of the present disclosure includes a base substrate 201 and a touch sensing layer 202 located over the base substrate 201. The touch sensing layer 202 comprises a photosensitive silver paste.

As mentioned above, the photosensitive silver paste, also called photosensitive silver colloid, photolithographic silver colloid or photolithographic silver paste, is a known material. The photosensitive silver paste may include a photosensitive component, a conductive component and an adhesive component. Depending on particular applications and needs, the photosensitive silver paste may also include other auxiliary components. In a conventional display device, the photosensitive silver paste can be used in a narrow frame design.

The inventors have found by research that the photosensitive silver paste material not only can be used as an electrode due to its good conductive property, but also has the characteristics of a photoresist such that it can be directly patterned by processes such as exposure, development and the like to form a desired pattern. Accordingly, if the touch sensing layer of the touch substrate is formed using the photosensitive silver paste material, there is no need to additionally form a photoresist pattern as in manufacturing a conventional ITO touch sensing layer. As a result, the process flow can be greatly simplified, the production efficiency can be improved, and the production cost can be reduced.

The touch sensing layer may be located at different locations of the touch substrate depending on particular applications and/or requirements. For example, the touch sensing layer may be formed on the upper surface of the base substrate.

According to another embodiment of the present disclosure, there is provided a touch panel, which may include the touch substrate described above.

FIGS. 3A and 3B illustrate an exemplary embodiment of a touch panel according to embodiments of the present disclosure, respectively.

As shown in FIG. 3A, in one exemplary example of a touch panel, the base substrate may be a color film substrate 301. The touch panel may further comprise a cover plate 303 located above the color film substrate 301, and an array substrate 304 located below the color film substrate 301, wherein a liquid crystal layer (not shown) is provided between the color film substrate 301 and the array substrate 304.

A touch panel 300 for a display device can be formed by forming a touch sensing layer 302 comprising the photosensitive silver paste on the color film substrate 301. Particularly, when the touch panel 300 comprises the array substrate 304 located below the color film substrate and the liquid crystal layer is provided between the color film substrate 301 and the array substrate 304, the touch panel 300 can be used to form a liquid crystal display device having touch sensing function.

In the touch panel 300 shown in FIG. 3A, the touch sensing layer 302 may comprise, for example, a transmitter electrode 302a and a receiver electrode 302b. Those skilled in the art can design the shapes of the transmitter electrode and the receiver electrode, the manner of connection thereof, etc depending on particular applications and/or requirements.

In certain exemplary embodiments, the cover plate 303 may be formed of glass, for example. For a better optical effect, the touch panel 300 may further comprise, for example, a first polarizing layer 305 located between the color film substrate 301 and the cover plate 303, and a second polarizing layer 306 located below the array substrate 304. The first polarizing layer 305 may cover the touch sensing layer 302, for example.

FIG. 3B illustrates another exemplary embodiment of a touch panel according to embodiments of the present disclosure. Unlike the touch panel 300 shown in FIG. 3A, in the touch panel 300′ shown in FIG. 3B, the base substrate is a cover plate 303. The touch panel 300′ further comprise a color film substrate 301 located above the cover plate 303, and a touch sensing layer 302 is formed on the surface of the cover plate 303 facing the color film substrate 301. The touch panel 300′ may further comprise an array substrate 304 located above the color film substrate 301, and a liquid crystal layer (not shown) is provided between the color film substrate 301 and the array substrate 304.

In certain exemplary embodiments, the cover plate 303 may be formed of glass, for example. For a better optical effect, the touch panel 300′ may further comprise, for example, a first polarizing layer 305 located between the color film substrate 301 and the cover plate 303, and a second polarizing layer 306 located above the array substrate 304. The first polarizing layer 305 may cover the touch sensing layer 302, for example.

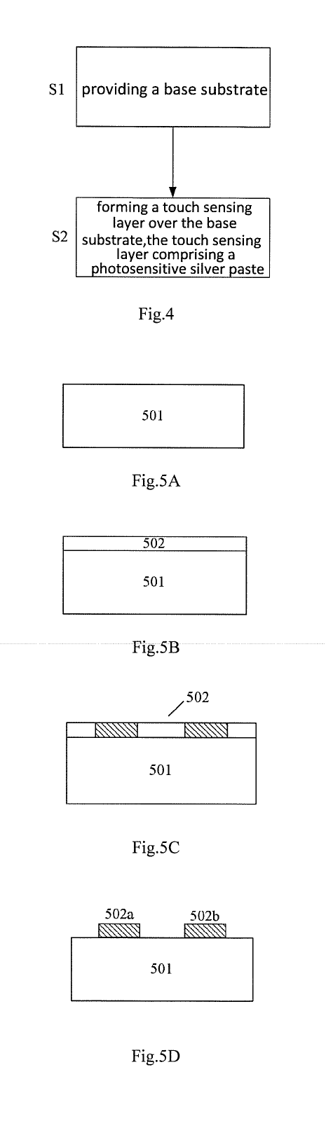

FIG. 4 shows a schematic diagram of a method of manufacturing a touch substrate according to embodiments of the present disclosure.

As shown in FIG. 4, a method of manufacturing a touch substrate comprises the steps of:
S1: providing a base substrate; and
S2: forming a touch sensing layer over the base substrate, the touch sensing layer comprising a photosensitive silver paste.

As described above, if the touch sensing layer of the touch substrate is formed using the photosensitive silver paste material, there is no need to additionally form a photoresist pattern as in manufacturing a conventional ITO touch sensing layer. As a result, the process flow can be greatly simplified, the production efficiency can be improved, and the production cost can be reduced.

According to an embodiment of the present disclosure, forming a touch sensing layer over the base substrate comprises forming a material layer comprising the photosensitive silver paste on the upper surface of the base substrate, and patterning the material layer to form a touch sensing layer.

According to another embodiment of the present disclosure, prior to patterning the material layer comprising the photosensitive silver paste, the material layer may be cured.

According to another embodiment of the present disclosure, patterning the material layer to form a touch sensing layer comprises exposing the material layer, and developing the exposed material layer so as to pattern the material layer to form a touch sensing layer.

FIGS. 5A-5D illustrate an exemplary process flow of a method of manufacturing a touch substrate according to embodiments of the disclosure.

As shown in FIG. 5A, a base substrate 501 is provided.

As shown in FIG. 5B, a material layer 502 comprising a photosensitive silver paste is formed on the upper surface of the base substrate 501. For example, a material layer 502 comprising a photosensitive silver paste having a thickness of 0.2 to 5 μm may be coated on the surface of the base substrate 501 using a coating machine. The thickness of the material layer 502 may be adjusted in accordance with electrical and optical requirements. Depending on particular applications and/or requirements, the material layer 502 may further include other components in addition to the photosensitive silver paste, such as components for enhancing electrical conductivity, and the like.

As shown in FIG. 5C, the material layer 502 comprising the photosensitive silver paste is exposed. For example, the base substrate 501 on which the material layer 502 is formed may be placed in an exposure machine for exposure treatment, so that undesired portions of the material layer 502 are denatured.

As shown in FIG. 5D, the exposed material layer 502 is developed so as to pattern the material layer, thereby forming a touch sensing layer. The touch sensing layer may comprise, for example, a transmitter electrode 502a and a receiver electrode 502b. Those skilled in the art can design the shapes of the transmitter electrode and the receiver electrode, the manner of connection thereof, etc depending on particular applications and/or requirements. For example, the exposed base substrate 501 on which the material layer 502 is formed may be placed in a developing solution for development treatment, such that the denatured portions of the material layer 502 react with the developing solution and are rinsed so as to be removed.

In certain exemplary embodiments, the surface of the base substrate 501 may be pre-cleaned prior to forming the material layer 502 comprising the photosensitive silver paste. By pre-cleaning, the foreign matter on the surface can be removed, thereby enhancing the adhesion of the surface of the base substrate to the material layer comprising the photosensitive silver paste to reduce the risk of wire breakage.

In certain exemplary embodiments, prior to exposing the material layer 502 comprising the photosensitive silver paste, the material layer may be cured. For example, the base substrate 501 on which the material layer 502 is formed may be placed in an oven for preheating treatment. Curing the material layer comprising the photosensitive silver paste can make the material layer more stable, thereby facilitating subsequent patterning process.

In certain exemplary embodiments, after developing the exposed material layer so as to pattern the material layer to form the touch sensing layer, the touch sensing layer may be inspected and the formed touch sensing layer may be maintained based on the inspection results. For example, it is possible to inspect whether the formed touch sensing layer involves deficiencies such as wire breakage, short circuit, and the like, and perform maintenance based on the inspection results. By inspecting and maintaining the formed touch sensing layer, the reliability of the formed touch substrate can be improved.

Since the photosensitive silver paste material is used, there is no need to first form a photoresist pattern by processes such as coating, exposure, development and the like, and then etch the ITO material using the photoresist pattern as a mask so as to form a touch sensing layer, as in manufacturing a conventional ITO touch sensing layer. Instead, the material layer comprising the photosensitive silver paste can be directly patterned. In particular, the material layer can be directly exposed and developed to form a touch sensing layer. Thus, the existing process for forming a touch sensing layer has been simplified.

According to an embodiment of the present disclosure, the base substrate may be a cover plate.

For the case where the touch sensing layer is formed on the cover plate, an exemplary process flow thereof may also referred to FIGS. 5A to 5D. That is, the base substrate 501 in FIGS. 5A to 5D is replaced with a cover plate. When a touch panel comprising a color film substrate needs to be formed, the cover plate may be disposed below the color film substrate such that the touch sensing layer is located on the surface of the cover plate facing the color film substrate.

According to another embodiment of the present disclosure, the base substrate may be a color film substrate. An array substrate may be disposed below the color film substrate, and a liquid crystal layer may be provided between the color film substrate and the array substrate.

A touch panel for a display device can be formed by forming a touch sensing layer comprising a photosensitive silver paste on a color film substrate. Particularly, in the case that the touch panel comprises an array substrate located below the color film substrate and a liquid crystal layer is provided between the color film substrate and the array substrate, the touch panel can be used to form a liquid crystal display device having touch sensing function.

According to an exemplary example, the touch sensing layer may be formed on a TFT-LCD substrate. The TFT-LCD substrate is formed by filling liquid crystal molecules between the array substrate and the color film substrate and then attaching the array substrate to the color film substrate. The TFT-LCD substrate may be uncut, and may also be a cut substrate including a single liquid crystal panel, or a cut substrate including a stack screen composed of a plurality of liquid crystal panels. Those skilled in the art can select specific size and constitution of the TFT-LCD substrate according to the requirements of the production equipment and the design.

Furthermore, the present disclosure further provides a display device, which may include the touch panel described above.

In the touch substrate and the method of manufacturing the same, the touch panel, and the display device comprising the touch panel as described above, since the touch sensing layer is formed using the photosensitive silver paste material, there is no need to additionally form a photoresist pattern as in manufacturing a conventional ITO touch sensing layer. As a result, the process flow can be greatly simplified, the production efficiency can be improved, and the production cost can be reduced.

Although the exemplary embodiments of the present disclosure have been described in detail with reference to the accompanying drawings, such description should be considered to be illustrative or exemplary rather than limiting. The present disclosure is not limited to the disclosed embodiments. Different embodiments described above and in the claims may also be combined. Those skilled in the art can understand and implement other variations of the disclosed embodiments based on the study of the drawings, the description and the claims while implementing the present disclosure as claimed. These variations also fall within the protection scope of the present disclosure.

In the claims, the word “comprising” does not exclude other elements or steps. The mere fact that certain measures are recited in mutually different dependent claims does not indicate that a combination of these measures cannot be used to advantage.

1. A touch substrate comprising:
a base substrate; and
a touch sensing layer over the base substrate, the touch sensing layer comprising a photosensitive silver paste.

2. The touch substrate according to claim 1, wherein the touch sensing layer is formed on an upper surface of the base substrate.

3. A touch panel comprising the touch substrate according to claim 1.

4. The touch panel according to claim 3, wherein the base substrate is a cover plate.

5. The touch panel according to claim 4, further comprising a color film substrate above the cover plate, the touch sensing layer being formed on a surface of the cover plate facing the color film substrate.

6. The touch panel according to claim 5, further comprising an array substrate above the color film substrate, wherein a liquid crystal layer is provided between the color film substrate and the array substrate.

7. The touch panel according to claim 3, wherein the base substrate is a color film substrate.

8. The touch panel of claim 7, further comprising a cover plate above the color film substrate.

9. The touch panel according to claim 8, further comprising an array substrate below the color film substrate, wherein a liquid crystal layer is provided between the color film substrate and the array substrate.

10-15. (canceled)

16. A display device comprising a touch panel according to claim 3.

17. The display device according to claim 16, wherein the base substrate is a cover plate.

18. The display device according to claim 17, further comprising a color film substrate above the cover plate, the touch sensing layer being formed on a surface of the cover plate facing the color film substrate.

19. The display device according to claim 18, further comprising an array substrate above the color film substrate, wherein a liquid crystal layer is provided between the color film substrate and the array substrate.

20. The touch panel according to claim 3, wherein the touch sensing layer is formed on an upper surface of the base substrate.

21. A method of manufacturing a touch substrate, comprising:
providing a base substrate; and
forming a touch sensing layer over the base substrate, the touch sensing layer comprising a photosensitive silver paste.

22. The method of manufacturing a touch substrate according to claim 21, wherein forming a touch sensing layer over the base substrate comprises:
forming a material layer including a photosensitive silver paste on an upper surface of the base substrate; and
patterning the material layer to form the touch sensing layer.

23. The method of manufacturing a touch substrate according to claim 22, further comprising: curing the material layer prior to patterning the material layer.

24. The method of manufacturing a touch substrate according to claim 22, wherein patterning the material layer to form the touch sensing layer comprises:
exposing the material layer; and
developing the exposed material layer so as to pattern the material layer to form the touch sensing layer.

25. The method of manufacturing a touch substrate according to claim 21, wherein the base substrate is a cover plate.

26. The method of manufacturing a touch substrate according to claim 21, wherein the base substrate is a color film substrate.
